(19) United States
(12) Patent Application Publication
(10) Pub. No.: US 2024/0212071 A1
(43) Pub. Date: Jun. 27, 2024

(54) ENERGY AND CARBON PERFORMANCE MONITORING SYSTEM AND METHOD FOR STATIONARY PRODUCTION UNITS

(71) Applicant: PETRÓLEO BRASILEIRO S.A. - PETROBRAS, Rio de Janeiro (BR)

(72) Inventors: Ana Paula Santana MUSSE, Rio de Janeiro (BR); Luciana Neves LOUREIRO, Rio de Janeiro (BR); Eduardo Choozo Arenas KAMI, Rio de Janeiro (BR); Leonardo DA SILVA RIBEIRO, Rio de Janeiro (BR); Pedro Henrique DE ALMEIDA BARBOSA, Rio de Janeiro (BR); Ronaldo Lucas Alkmin FREIRE, Sao Jose dos Campos (BR); Rodrigo Chaves Cardoso DE OLIVEIRA, Rio de Janeiro (BR); Gilcelia Carlos BORGES, Rio de Janeiro (BR); Leonardo Monteiro Barbosa LIMA, Santos (BR); Ricardo Alves DE SOUZA, Rio de Janeiro (BR)

(21) Appl. No.: 18/391,021

(22) Filed: Dec. 20, 2023

(30) Foreign Application Priority Data
Dec. 25, 2022 (BR) BR 1020220265887

(51) Int. Cl. G06Q 50/06; G06F 17/11

(52) U.S. Cl. CPC G06Q 50/06; G06F 17/11

(57) ABSTRACT

The present invention pertains to the field of measurement, monitoring and systematic supervision of carbon management and energy performance in oil and gas production and exploration units. More specifically, the present invention relates to a method of monitoring energy and carbon performance for stationary production units that comprises: identifying stored operational data on energy consumption and greenhouse gas emissions; structuring the operational data of interest; calculating at least one energy and carbon performance indicator corresponding to at least one level of a stationary production unit (SPU) among: installation, system, equipment, or a combination thereof; connecting information and structured data obtained from the operational data of one or more stored SPU levels; and building a display panel to display one or more displays that present the calculated performance indicators in real time. The present invention also describes an energy and carbon performance monitoring system for stationary production units.

### FIELD OF THE INVENTION

The present invention is applied in the field of measurement, monitoring and systematic supervision of carbon management and energy performance in oil and gas production and exploration units.

### BACKGROUNDS OF THE INVENTION

Once designed and built, petrochemical sector platforms or, more generally, stationary production units (SPUs) become limited in promoting significant changes in their energy or emissions performance, so it is quite difficult to find a way to operate the units at a higher level of efficiency than initially anticipated. However, it is common for the operating mode of the units to end up deviating from the ideal design condition to a condition of lower efficiency.

By way of example, there are several production and exploration units that can operate with one less turbogenerator without impacting production, or whose compression and pumping systems operate with unnecessary cycles, especially where this adjustment requires manual intervention.

Currently, to monitor and supervise energy performance and greenhouse gas emissions (such as CO₂ and methane, for example), many industries need to implement specific and dedicated devices for these functions.

There are also systems and methods that are dedicated to predicting an ideal energy performance schedule to meet the required total production demand, or even methodologies that supervise the emissions performance of certain equipment on a monthly basis.

However, the systems and methods known today do not address to energy efficiency measures in a systemic, precise way, carried out in real time and at any level within a stationary production unit, whether the unit as a whole or individualized systems, subsystems and equipment.

Accordingly, there is a need in the industry for the development of monitoring systems and methods that make it possible to measure certain energy parameters effectively and accurately, without the need for specific and dedicated instrumentation, and that are capable of defining indicators of energy and carbon performance, at different levels in a stationary production unit, to identify potential causes of low performance of a given system or equipment, thus supporting more agile decision-making and further contributing to the reduction of emissions of greenhouse gases into the atmosphere.

### SUMMARY

The search for the history of the invention in question led to some documents that disclose matters within the technological field of the present invention.

Document WO 2004/029557 describes that the energy efficiency can be monitored by recording data related to the consumption of resources (such as natural gas, electricity and water) together with production data or other related data relevant to an industrial or commercial application. Resource consumption data is normalized against production or other data to provide performance indicator values that are displayed, in graphical or tabular form, against reference values representative of benchmark efficiency levels. Reference values are defined for corresponding production levels or other data to provide a comparison that takes into account the system nonlinearities. The aforementioned document, however, does not present details of how carbon emissions would be monitored in a stationary production unit, SPU, including a set of industrial assets present in the same and not necessarily physically identical. Furthermore, the aforementioned document also does not disclose or suggest a method capable of monitoring and indicating the decision-making of industrial assets, at different levels (installations, operating systems and individual equipment), which can operate in two completely different situations in terms of energy and carbon performance: reinjection or exportation of the gas.

Document US 2016/0093074 describes an energy management system that includes an information collector that is configured to collect first information according to the passage of time. Furthermore, the system of said document also includes a display controller that is configured to group second information to a plurality of first units that are divided by one or a plurality of physical or logical boundaries of a power management entity and a plurality of second units that are divided by one or a plurality of boundaries of an operational status to cause the collected result to be displayed on a screen based on the first information collected by the information collector for each of the first units. The first information including energy consumption information of the energy management entity, or information about factors involved in a change in the energy consumption of the energy management entity, and the second information including the first information or energy performance specified for each of the second units divided by one or a plurality of boundaries of an operational status that changes over time of the energy management discipline. This document, however, fails to disclose or suggest a method and system for monitoring carbon emissions in a set of industrial assets present in a SPU. In addition, the document does not disclose or suggest a monitoring method and system that are capable of monitoring industrial assets in two completely different situations in terms of energy and carbon performance: reinjection or exportation of the gas.

Finally, document US 2017/0285591 discloses a method for energy management that includes steps of collecting data over a period of time, identifying groupings of data within the data, categorizing the groupings of data within the period of time, analyzing data groupings and assigning a classification to the time period. Real-time data can be compared to scheduled performance. Real-time notifications can be provided to a user where energy is being used inefficiently. The energy efficiency of meters within a location can be rated to identify meters where energy is being used inefficiently. The document, however, fails to disclose or suggest a method and system for monitoring the carbon emissions. Furthermore, this document does not disclose or suggest a method capable of monitoring a set of industrial assets in a SPU at different levels (installations, operating systems and individual equipment) and in two completely different situations in terms of energy and carbon performance: reinjection or exportation of the gas.

### BRIEF DESCRIPTION OF THE INVENTION

The present invention pertains to the field of technologies aimed at monitoring energy and carbon performance to be applied in stationary production units (SPUs) in the oil and gas industry.

Accordingly, the present invention provides a monitoring panel that allows users to measure and supervise, in real time, the performance of existing units at three different levels: installation, systems, and equipment, through a set of key performance indicators (KPIs) developed for the invention.

The system and method proposed by the present invention make it possible to implement measurements and define performance indicators in energy and carbon that support decision-making in a more agile and precise way. The approach developed by the present invention for measuring energy and carbon performance at the different levels mentioned above is based on the definition and calculation of energy and carbon indicators to monitor the global performance of the stationary production unit and to detect performance deviations related to a specific system or equipment.

The calculations carried out to define the indicators are based on data available from the most energy-intensive equipment, without the need of installing specific instrumentation on the equipment. Furthermore, based on these data, a typical energy demand profile of an existing unit can be used as a guideline for selecting the equipment to be monitored.

Therefore, the systems and methods developed by the present invention are implemented on a computer and represented by means of a panel for real-time monitoring of energy and greenhouse gas emissions (calculated as CO₂ equivalent, notably, CO₂, N₂O and CH₄) obtaining, among others, the following technical solutions: reduction of the energy consumption in stationary oil production units; reduction of the natural gas burning in specific equipment; reduction of time in data structuring; lower level of human intervention to automate the proposed metrics; implementation of measurements and definition of performance indicators in energy and carbon that support decisions in a more agile and precise way; detection of deviations more quickly.

Accordingly, the advantages and objectives of the present invention mentioned above are achieved by providing a method of monitoring energy and carbon performance for stationary production units that comprises: identifying stored operational data on energy consumption and greenhouse gas emissions; structuring the operational data of interest; calculating at least one energy and carbon performance indicator corresponding to at least one level of a stationary production unit (SPU) among: installation, system, equipment, or a combination thereof; connecting information and structured data obtained from the operational data of one or more stored SPU levels; and building a display panel to display one or more displays that present the calculated performance indicators in real time.

Furthermore, in an embodiment of the present invention, an energy and carbon performance monitoring system for stationary production units is provided, implemented on a computer, comprising a memory, a processor and a screen; wherein the memory contains a set of instructions that, when executed by the processor, perform the steps of: identifying stored operational data on energy consumption and greenhouse gas emissions; structuring the operational data of interest; calculating at least one energy and carbon performance indicator corresponding to at least one level of a stationary production unit (SPU) among: installation, system, equipment, or a combination thereof; connecting information and structured data obtained from the operational data of one or more stored SPU levels; and building a display panel to display one or more displays that present the calculated performance indicators in real time.

### BRIEF DESCRIPTION OF THE FIGURES

The brief description above, as well as the detailed description below of the preferred embodiments of the invention in question will be better understood when read together with the attached drawings. For the purpose of illustrating the present invention, embodiments thereof are shown in the drawings. It must be understood, however, that the invention in question is not limited only to the precise arrangements and instruments as shown.

Therefore, the present invention will be described below with reference to typical embodiments thereof and also with reference to the attached drawings, in which:

The patent or application file contains at least one drawing executed in color. Copies of this patent or application publication with color drawings will be provided by the Office upon request and payment of the necessary fee.

FIG. 1 presents a general view of a SPU displays as a function of energy use and consumption, according to an exemplary configuration of the present invention.

FIG. 2 presents a burned gas metric dial, according to an exemplary configuration of the present invention.

FIG. 3 presents a total CO₂ equivalent emission metric dial, according to an exemplary configuration of the present invention.

FIG. 4 presents a total production metric dial, according to an exemplary configuration of the present invention.

FIG. 5 presents a total energy metric dial, according to an exemplary configuration of the present invention.

FIG. 6 presents a performance visualization at the SPU level, according to an exemplary configuration of the present invention.

FIG. 7 presents a visualization of trends, according to an exemplary configuration of the present invention.

FIG. 8 presents the availability and performance of systems and equipment, according to an exemplary configuration of the present invention.

FIG. 9 presents the availability and performance of individual equipment, according to an exemplary configuration of the present invention.

FIG. 10 presents a first combination of displays together generated by the display panel, according to an exemplary configuration of the present invention.

FIG. 11 presents a second combination of displays together generated by the display panel, according to an exemplary configuration of the present invention.

FIG. 12 shows a main screen with a portfolio of SPUs per business unit (UN), according to an exemplary configuration of the present invention.

FIG. 13 shows a screen with detailed energy and carbon performance information per SPU, according to an exemplary configuration of the present invention.

FIG. 14 presents a gas display acquired for a specific SPU, according to an exemplary configuration of the present invention.

FIG. 15 presents a production display (boe/day) for a specific SPU, according to an exemplary configuration of the present invention.

FIG. 16 presents a Total Energy (MW) display for a specific SPU, according to an exemplary configuration of the present invention.

FIG. 17 presents a display of Total CO2 eq Emission (t/day) for a specific SPU, according to an exemplary configuration of the present invention.

FIG. 18 presents a Sankey Diagram (energy flow) for a specific SPU, according to an exemplary configuration of the present invention.

FIG. 19 presents a table with the main systems of a specific SPU, according to an exemplary configuration of the present invention.

FIG. 20 presents an “indicator” view for a specific SPU, according to an exemplary configuration of the present invention.

FIG. 21 presents the behavior of the indicators over the time horizon, according to an exemplary configuration of the present invention.

FIG. 22 also presents the behavior of the indicators over the time horizon, according to an exemplary configuration of the present invention.

FIG. 23 presents the efficiencies at the equipment level, according to an exemplary configuration of the present invention.

### DETAILED DESCRIPTION OF THE INVENTION

In the following, reference is made in detail to the preferred embodiments of the present invention illustrated in the attached drawings. Whenever possible, the same or similar reference numbers will be used throughout the drawings to refer to the same or similar features. It should be noted that the drawings are in simplified form and are not drawn to precise scale; so, slight variations are anticipated.

The techniques and methodologies that will be described below refer to a system and method for monitoring energy and carbon performance for stationary production units. In particular, the system and method are implemented on a computer and provide an energy and carbon performance monitoring panel that allows users to measure and supervise, in real time, the performance of existing platforms (stationary units) at three different levels: installation, systems and equipment, through a set of specific performance indicators developed by the present invention. It should be highlighted that the level called “installation” corresponds to a production platform, the level called “system” corresponds to an integrated set of equipment capable of performing a production function or supporting the process in the installation, and the level called “equipment” corresponds to the implement itself, analyzed individually.

The present invention aims at serving as a tool for monitoring and evaluating the use of the produced gas, consumption, use for energy generation and the impacts of this distribution on carbon emissions from Stationary Production Units (SPUs). The system and method are implemented on a computer and represented through a monitoring panel whose main function is to present, in real time and in a structured way, the parameters, metrics, indicators and automated calculations of the most relevant metrics in terms of greenhouse gas emissions and energy efficiency of the SPU for the adequate supervision by the operational areas.

Furthermore, the present invention provides the efficiency calculation of main equipment and equipment systems related to energy use and consumption.

By means of the system and method developed by the present invention, it is possible to visualize in real time the impact of operational occurrences through specific indicators, calculated according to the monitoring metrics for each level of the SPU. Obtaining these indicators through the carried-out calculations allows faster operational action in order to mitigate such impacts.

In the context of the present invention, data and parameters of equipment and systems of a SPU are stored in a computational environment in a plant information infrastructure (Plant Information—PI). Therefore, this infrastructure is responsible for acquiring the data and parameters of interest to be used (i.e., process information generated directly from field measurement instruments and related mainly to energy consumption and greenhouse gas emissions) and store them in a historical database. The PI infrastructure, in turn, is integrated into a central server in an integrated operations center (IOC). This central server is a Plant Information Asset Framework Server.

Thus, according to an embodiment of the present invention, the method of monitoring energy and carbon performance for stationary production units comprises an initial step to identify operational data of interest stored in the PI infrastructure.

Additionally, the method further comprises structuring the operational data of interest on the PI asset structure server. This step, more specifically, comprises: organizing the assets in order of priority (hierarchies) within the asset structure; standardizing configurations; centralizing data from multiple sources (relational databases, calculated data tables); standardizing themes (template) and units of measurement; and creating result tags.

Still according to an embodiment of the present invention, the method comprises calculating at least one energy and emissions performance indicator corresponding to at least one SPU level among: installation, system, equipment, or a combination thereof. It is worth highlighting that the indicators are calculated based on energy performance metrics and/or carbon performance metrics. Within a computational environment, metrics are described using an algorithm to calculate results and indicators.

The energy performance indicators and metrics used in accordance with an embodiment of the present invention are described in detail below.

### For the Installation Level:

Therefore, to evaluate the performance of existing SPUs at the installation level, an energy performance metric applicable to the entire SPU is established, in order to represent the energy efficiency of the platform in the form of an energy intensity indicator (IIE) which relates the global energy contribution of the platform to its net exported production, in barrels of oil equivalent (boe), carried out as follows:

$${IIE}_{UEP} = \frac{{ApEn}_{UEP}}{{PrEx}_{UEP}} \qquad ( E \text{.1} )$$

wherein:
IIE_{UEP} is the SPU energy intensity indicator, in Btu/boe (MJ/boe);
ApEn_{UEP} is the global energy contribution to the SPU, in Btu (MJ); and
PrEx_{UEP} is the net exported production, in boe.

It should be noted that SPU's oil (P_{Oil}) and gas (P_{Gas}) productions are expressed in Barrels of Oil Equivalent (boe).

P_{Gas} considers the entire volume of gas lifted to the SPU, which, after the processing steps, will be divided into the following portions: Consumption Gas, Flaring Gas (loss), Lift Gas, Injected Gas and Exported Gas (E_{Gas}).

Furthermore, according to an embodiment of the present invention, to determine the energy contribution contained in equation E.1 above, it is necessary to measure the fuel gas (or diesel) consumption of the SPU and its calorific value during the period of calculation of this indicator. Fuel gas must be understood as being equivalent to a mixture of process gases used in burning to generate energy in the SPU, while flare gas refers to the portion of the gas sent for burning in the flare.

Notably, IIE_{UEP} considers the metric referring to net exported production in the denominator of equation E.1. However, this metric alone may not be sufficient to compare energy performance between platforms of different complexity or operating modes (i.e., pre-salt platforms x post-salt platforms; gas exportation x reinjection, etc.). Thus, according to an alternative embodiment of the present invention, when platforms of different complexity or modes of operation are analyzed, an analysis of this indicator is carried out segregated for groups of platforms of the same complexity (clusters), or, alternatively, there is carried out a normalization of the metric that allows the performance of different SPUs to be compared, which will invariably be preceded by the analysis of the collected data.

### For the Systems Level:

Furthermore, according to an embodiment of the present invention, the adoption of an indicator for the electrical generation system presents itself as an interesting complementary solution to measuring the individual efficiency of gas turbines in turbogenerator packages, for the following reasons:
in electrical generation systems of SPUs that typically operate with an association of turbogenerators in parallel, it is desirable to monitor the global energy performance of this system;
on platforms that do not have dedicated flow rate instruments for individual measurement of the fuel consumption of their turbogenerators, measuring energy performance at the level of this type of equipment becomes impractical;
the electrical generation system can be more easily comparable between different SPUs, as there is great similarity in the arrangement and model of turbines in this system between the platforms.

Thus, the present invention provides, in one of its embodiments, a global efficiency indicator of the electrical energy generation system of the SPU (IE_{SisGer}), as follows:

$${IE}_{SisGer} = A \cdot \frac{{Pot}_{SisGer}}{{\dot{m}}_{f \_ SisGer} \cdot PCI} \qquad ( E \text{.2} )$$

wherein:
IE_{SisGer} is the global efficiency indicator of electrical energy generation system of the SPU;
A is the energy conversion factor, 3412.14·kWh/BTU(3600·kWh/kJ);
Pot_{SisGer} is the net electrical power provided by the electrical generation system, in kW;
\dot{m}_{f_SisGer} is the total mass flow rate of fuel for the electrical generation system, in lb/h (kg/h); and
PCI is the lower calorific value of the fuel, in Btu/lb (KJ/kg).

According to the present invention, for process gas compression systems, the evaluation of the global efficiency of each SPU gas compression system (vapor recovery unit—VRU, main, exportation, CO₂ and injection) allows the identification of losses related or not to compression packages, such as the gas recirculation through the anti-surge system, non-optimized load balance between compressors operating in parallel, abnormal pressure drops in the piping system, etc.

To achieve this purpose, the approach of the present invention consists of evaluating only the part of the gas absorbed power related to the net gas flow delivered by the compression system, instead of the total gas flow through the compressor casings.

Ideally, the indicator for this type of system could be given by the ratio between the net flow of gas delivered by the compression system to the plant and the total power required to drive the compression system. However, for cases where there is no net gas flow rate meter delivered by each compressor train to the gas processing plant, the present invention provides a global efficiency indicator of the gas compression system calculated as follows:

$${IE}_{SisComp} = \frac{{\dot{m}}_{SisComp} \cdot Δ {h}_{SisComp}}{{Pot}_{SisComp}} \qquad ( E \text{.3} )$$

wherein:
IE_{SisComp} is the global efficiency indicator of the SPU gas compression system;
\dot{m}_{SisComp} is the net mass flow rate delivered by the compression system, in lb/s (kg/s);
Δh_{SisComp} is the sum of the enthalpy added to the gas by all compressor sections, on average between machine trains, in Btu/lb (KJ/kg); and
Pot_{SisComp} is the total power required to activate the compression system, in HP (kW).

### For the Equipment Level:

The present invention further provides indicators calculated based on energy performance metrics for SPU equipment.

Particularly, in order to enable the identification of the origin of possible anomalies (or distortions) in the SPU energy performance, the present invention further provides solutions based on the calculation of complementary indicators applicable to the main energy-consuming equipment of the SPU. In this case, the purpose of the present invention is that each type of equipment that falls into this category has its own characteristic indicator that best represents its energy performance.

Notably, variations in the performance of the gas turbines, gas processing plant compressors and larger size pumps at the SPU (such as water injection pumps) have a great influence on the energy performance of the SPU as a whole, and should, therefore, be included in the list of equipment with specific energy performance indicators and metrics.

Thus, according to an embodiment of the present invention, the indicator that best represents the energy performance of a gas turbine is obtained from its efficiency, as calculated below:

$${IE}_{Turb} = A \cdot \frac{{Pot}_{Turb}}{{\dot{m}}_{f \_ Turb} \cdot PCI} \qquad ( E \text{.4} )$$

wherein:
IE_{Turb} is the efficiency indicator of a SPU gas turbine;
A is the energy conversion factor, 3412.14·kWh/BTU(3600·kWh/kJ);
Pot_{Turb} is the shaft power of the gas turbine, in kW;
\dot{m}_{f_Turb} is the total mass flow rate of fuel for the gas turbine, in lb/h (kg/h); and
PCI is the lower calorific value of the fuel, in Btu/lb (KJ/kg).

In the case of a turbogenerator, the energy generated by the turbine is obtained directly through the electrical power delivered by the generator plus the mechanical and electrical losses of the gearbox and generator during the calculation period. In the case of a turbocharger, the energy produced by the turbine can be obtained indirectly (by determining the power absorbed on the compressor shaft) or directly using a torque wrench installed on the coupling.

Furthermore, according to an embodiment of the present invention, in the case of a centrifugal compressor, the most representative parameter for measuring its energy performance is the polytropic efficiency indicator (IE_{P}), which can be obtained if the composition and the gas inlet and outlet conditions are known, through the following equations:

$${T}_{2} = {( \frac{{P}_{2}}{{P}_{1}} )}^{\frac{n - 1}{n}} \cdot {T}_{1} \qquad ( E \text{.5} )$$

$$\frac{n - 1}{n} = \frac{k - 1}{k \cdot {IE}_{p}} \qquad ( E \text{.6} )$$

wherein:
IE_{P} is the polytropic efficiency indicator of the SPU compressor;
T₁ is the absolute temperature at the compressor suction, in K;
T₂ is the absolute temperature at the compressor discharge, in K;
P₁ is the absolute pressure at the compressor suction, in kPa;
P₂ is the absolute pressure at the compressor discharge, in kPa;
k is the adiabatic expansion coefficient; and
n is the polytropic exponent.

Finally, in relation to a SPU centrifugal pump, its energy performance can be represented based on its efficiency indicator, as calculated below:

$${IE}_{b} = \frac{Δ P . \dot{Q}}{{Pot}_{abs}} \qquad ( E \text{.7} )$$

wherein:
IE_{b} is the efficiency indicator of a SPU pump;
Δp is the differential pressure provided by the pump, in kPa;
\dot{Q} is the volumetric flow rate of the pumped fluid, in m³/s; and
Pot_{abs} is the power absorbed by the pump, in kW.

It is worth highlighting that the power absorbed in the pump shaft (Pot_{abs}) can be obtained by measuring the current and voltage of the electric drive motor, deducting the mechanical losses of the drive motor. With this data, the efficiency of the pump can be determined by measuring the suction and discharge pressures of the pumped fluid and the operating flow rate (\dot{Q}) of the equipment.

The carbon performance indicators and metrics used in accordance with an embodiment of the present invention are described in detail below.

According to the present invention, it is recommended to implement indicators and metrics to evaluate the carbon performance of those sources of greenhouse gas emissions that have a direct relation with the energy performance of the SPUs, as detailed below:

### For the Installation Level:

In this case, the overall carbon efficiency of the SPU can be measured by a carbon intensity indicator, or greenhouse gas intensity indicator, according to the following calculation:

$$IGEE = \frac{{EmCO}_{2 \_ UEP}}{{PrEx}_{UEP}} \qquad ( E \text{.8} )$$

wherein:
IGEE is the SPU's greenhouse gas intensity indicator, in kg CO₂/boe;
EmCO_{2_UEP} is the total CO₂ emission associated with energy consumption in the SPU, in kg CO₂; and
PrEx_{UEP} is the net exported production of the SPU, in boe.

The portion of Emissão_{UEP} associated with combustion in gas turbines can be determined by direct measurements of the gas turbine emissions or by stoichiometric calculation protocols.

### For the Systems Level:

At the systems level, the present invention provides for the establishment of new carbon performance metrics that relate, respectively, the CO₂ equivalent emissions of the electrical energy generation systems and turbocharging systems of the SPU with the useful energy delivered by each one of these systems, in the form of carbon intensity indicators, as follows:

$${IIC}_{SisGer} = \frac{{EmCO}_{2 \_ SisGer}}{{Pot}_{SisGer}} \qquad ( E \text{.9} )$$

wherein:
IIC_{SisGer} is the carbon intensity indicator of a SPU electrical generation system, in kg CO₂/MWh;
EmCO_{2_SisGer} is the total CO₂ emission associated with the SPU electrical generation system, in kg CO₂/h; and
Pot_{SisGer} is the net electrical power supplied by the SPU electrical generation system, in MW,

$${IIC}_{SisComp} = \frac{{EmCO}_{2 \_ SisComp}}{{Pot}_{SisComp}} \qquad ( E \text{.10} )$$

wherein:
IIC_{SisComp} is the carbon intensity indicator of a compression system driven by a SPU gas turbine, in kg CO₂/MWh;
EmCO_{2_SisComp} is the total CO₂ emission associated with the compression system driven by the SPU gas turbine, in kg CO₂/h; and

Pot_{SisComp} is the net power delivered to the gas by the compression system driven by a gas turbine, in MW.

It should be further highlighted that, in order to determine the energy generation (in MWh) constant in E.9 and E.10, the total electrical power supplied by the turbogenerators (or motor generators) of the generation system must be obtained, as well as the power absorbed in the shaft of the compressors driven by gas turbines, in a similar way to what was previously described for the calculation of energy performance indicators at the equipment level.

### For the Equipment Level:

Finally, with the purpose of facilitating the search for the causes of possible anomalies (or distortions) in the SPU carbon performance, the present invention further provides the creation of a complementary metric applicable to equipment in the SPU processes that most contribute to emissions of greenhouse gases: use of fuel for electrical generation/mechanical drive.

In this sense, the proposal consists of establishing a carbon intensity indicator that relates the individual emissions of each gas turbine (and, when applicable, combustion engine) with its energy produced, as follows:

$${IIC}_{TG} = \frac{{EmCO}_{2 \_ TG}}{{Pot}_{TG}} \qquad ( E \text{.11} )$$

wherein:
IIC_{TG} is the carbon intensity indicator associated with equipment driven by a gas turbine, in kg CO2/MWh;
EmCO_{2_TG} is the emission associated with the SPU gas turbine, in kg CO₂/h; and
Pot_{TG} is the net power delivered by the gas turbine, in MW.

After calculating the indicators and metrics of interest, as explained above, the method of the present invention further comprises interconnecting information and data obtained through a flow-based tool for visual programming (Node RED). In other words, the tool is configured to connect the information and data structured on the PI asset structure server, obtained from operational data from one or more levels of the SPU stored in the PI infrastructure, with the calculations of the indicators obtained in the previous step.

Finally, the method of the present invention further comprises constructing a results display panel, using the flow-based tool for visual programming, to display one or more displays that present in real time and in a structured way, the parameters and automated calculations that are most relevant in terms of emissions and energy efficiency for the adequate supervision by operational areas.

Thus, the display panel constructed, in accordance with the present invention, acts as a tool for monitoring and evaluating the use of the produced gas, consumption, use for energy generation and the impacts of this distribution on the carbon emissions of the SPU.

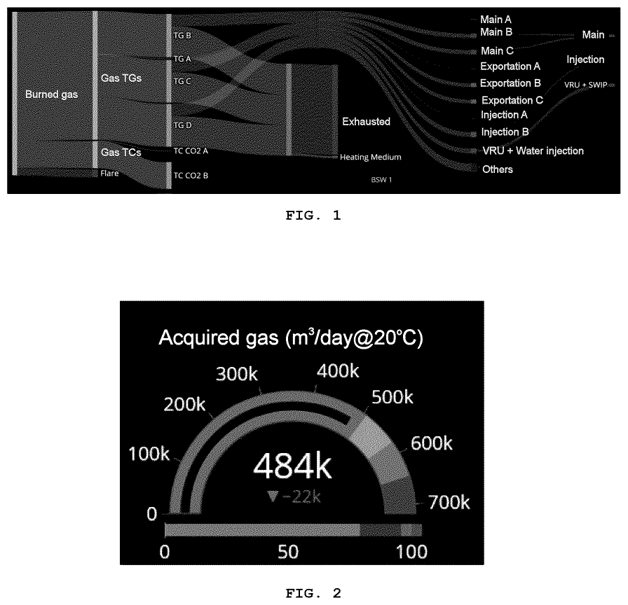

In this sense, as shown in FIG. 1, the display panel of the present invention is configured to display one or more displays through a Sankey graph, which allows immediate visualization of the distribution of portions of gas use and consumption according to the operating condition of each equipment or system involved in monitoring within a SPU.

Thus, a portion of the graph displays gas usage and burning data for the following parameters:
Burned gas:
   Fuel gas (yellow area in the graph in FIG. 1):
      Gas consumed in Turbogenerators (TGs)
      Gas consumed in Turbochargers (TCs)
   Flared gas (area in red in the graph in FIG. 1).

Another portion of the graph displays energy generation and use data with the following parameters:
Energy generation:
   TGs (Turbogenerators)
   TCs (Turbochargers)
   Flared gas
Energy utilization:
   Heating
Loss:
   Exhausted.
Consumption:
   Main compressors.
   Export compressors.
   Gas injection compressors.
   Water Injection.
   VRU.
   Others.

According to an embodiment of the present invention, as presented exemplarily in

FIGS. 2 to 5, the display panel of the present invention is further configured to display one or more displays through one or more metric dials.

The displayed metric dials comprise at least one dial from the group consisting of: a burned gas dial, a total CO₂ emission dial, a total production dial, and a total energy dial.

The burned gas dial shows the portions of flare burning gas and fuel gas consumed in gas turbines and inert gas generation (GGI). It allows immediate visualization of the relative distribution between gas lost when burning through the flare and the gas burned to generate energy (as shown in the lower horizontal bar in FIG. 2). Preferably, each unit must evaluate the acceptable reason for monitoring, according to the operational condition of the SPU.

The total CO₂ emission dial presents the portions of flare burning gas and fuel gas consumed in gas turbines and inert gas generation (GGI) for energy generation calculated as CO₂ equivalent. It allows immediate visualization of the relative distribution between burning emissions through emissions for energy generation (as shown in the lower horizontal bar of FIG. 3).

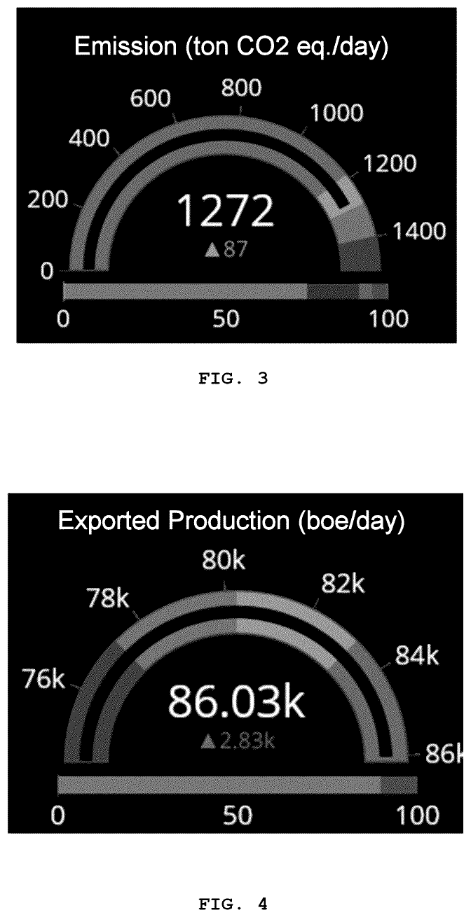

The total production dial, as shown in FIG. 4, comprises the oil production (P_{Oil}) and total gas production (P_{Gas}) converted into boe/day. Allows immediate visualization of the relative distribution between P_{Oil} and P_{Gas}.

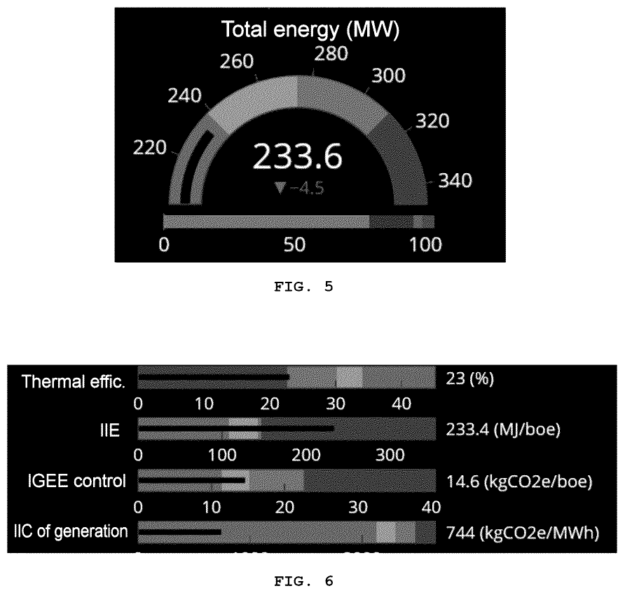

Furthermore, the total energy dial, shown in FIG. 5, presents the flare burning gas and fuel gas consumed in gas turbines and inert gas generation (GGI) for power generation calculated in energy. It allows the immediate visualization of the relative distribution between emissions from burning through the flare and emissions for energy generation.

Furthermore, in an embodiment of the present invention, as shown exemplarily in FIG. 6, the display panel of the present invention is configured to display one or more displays through at least one performance indicator at the SPU level of a group consisting of: thermal efficiency; SPU energy intensity indicator (IIE-UEP); GHG intensity indicator that differs from IGEE-SPU as it considers only the portion of exported gas (E_{Gas}) as gas production and energy generation carbon intensity indicator (IIC).

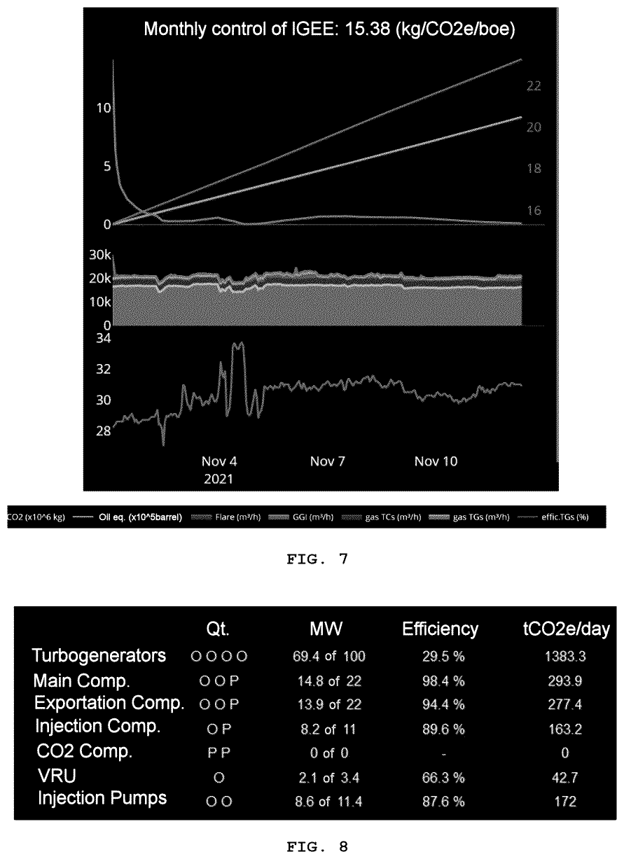

The display panel of the present invention, as shown in FIG. 7, is configured to further display one or more trend displays. The trend displays consolidate the accumulated result of the IGEE monthly control until the current date (in blue), allowing visual analysis of its correlation with the other mapped operational parameters: Flare, GGI, TCs gas, TGs gas and TGs Efficiency.

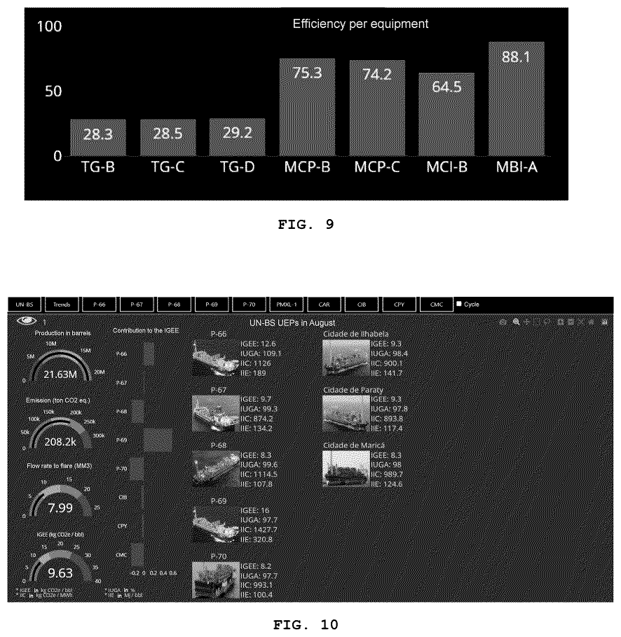

Furthermore, the display panel of the present invention, as shown in FIGS. 8 and 9, by way of example, is configured to display one or more displays of availability and performance of the SPU systems and efficiency per SPU equipment.

In relation to the availability and performance displays of the SPU systems (FIG. 8), the operational availability of the main equipment related to energy use and consumption is presented in a consolidated manner through one or more parameters of a group consisting of: availability of equipment (where “O” means “Operating” and “P” means “Stopped”); carried-out generation compared to generation capacity; operation efficiency; and carbon efficiency.

The efficiency displays by equipment (FIG. 9) present in a consolidated manner the efficiency of the main generation equipment.

It is further worth highlighting that the method of the present invention is also implemented in order to record historical data, as previously described, to allow a graphical visualization of time series of the measured results. Historical data allows to identify deviations and trends in performance relative to a baseline period. In addition, it makes it possible to identify the main energy consumers or deviations in the expected greenhouse gas emissions profile when unforeseen operational situations occur, such as equipment failures, for example, related to a certain platform system.

The displays selected to make up the panel also make it possible to measure the impact on emissions and fuel consumption of the SPU (natural gas and diesel). Performance improvement actions such as, for example, optimizing the load of the turbines of the main generation system or adjusting the recycle flow rates of the compression systems of the gas processing plant are easily identified and can be supervised using the panel.

FIGS. 10 and 11 present, by way of example, a plurality of displays together generated by the display panel, according to an embodiment of the present invention.

Furthermore, in an embodiment of the present invention, an energy and carbon performance monitoring system for stationary production units is provided, implemented on a computer, comprising a memory, a processor and a screen; wherein the memory contains a set of instructions that, when executed by the processor, perform the steps of: identifying stored operational data on energy consumption and greenhouse gas emissions; structuring the operational data of interest; calculating at least one energy and carbon performance indicator corresponding to at least one level of a stationary production unit (SPU) among: installation, system, equipment, or a combination thereof; connecting information and structured data obtained from the operational data of one or more stored SPU levels; and building a display panel to display one or more displays that present the calculated performance indicators in real time.

As would be readily evident to a person skilled in the art, the energy and carbon performance monitoring system for stationary production units of the present invention also comprises all the technical features explained and described in terms of the method.

In addition, the various aspects, implementations and features disclosed may be implemented using, for example, one or more than one method; an apparatus; a system; a processing or computing apparatus, system, tool or device for carrying out a method; a computer program or other set of instructions stored on a computer-readable storage medium or in a memory; and an apparatus that includes a program or set of instructions stored on a computer-readable storage medium or memory.

In order to highlight the applicability and distinctiveness of the present invention, an example of embodiment will be described below.

Example of application of the carbon and energy performance system/panel

The energy and carbon performance monitoring system and method for stationary production units is currently used in the monitoring and decision-making of thirty-two (32) stationary production units (SPUs) of the semi-submersible and floating production storage, and offloading (FPSO) types. The measurement and optimization of energy and carbon performance in these installations comprises a set of activities aimed at reducing greenhouse gas (GHG) emissions, encompassing both the consumption of fuel gas and the use of electrical energy, with a focus on the Operational Efficiency of the unit. In this sense, the panel supports decision-making in energy and carbon through:
a. Operational actions and/or procedures;
b. Management actions;
c. Maintenance actions;
d. Adequacy or improvement of installations.

The critical analysis of the performance metrics proposed in the methodology, obtained practically instantly through the system, allows the rapid identification of deviations through their comparison with reference values or initially planned and committed values, enabling the issuance of abnormality alerts, as well as proposing actions to mitigate negative deviations. It is noteworthy that the previous practice involved the manual insertion of consolidated carbon performance data, only at the installation level as per the previous month closing, into an emissions management system.

In this sense, the system and methodology for measuring and optimizing performance in energy and carbon enabled a series of advances in relation to the state of the art. For example, automation of the information input process, assumptions and mathematical modeling ensure comparability between data, in addition to minimizing human errors. The availability of metrics practically instantly at system and equipment levels allows anomalies to be diagnosed and operations to be optimized, so that the emissions targets supervised by senior management and the market are achieved. The availability of historical data in a database also contributes to the operationalization of energy performance management systems such as that proposed in the ISO 50001 standard.

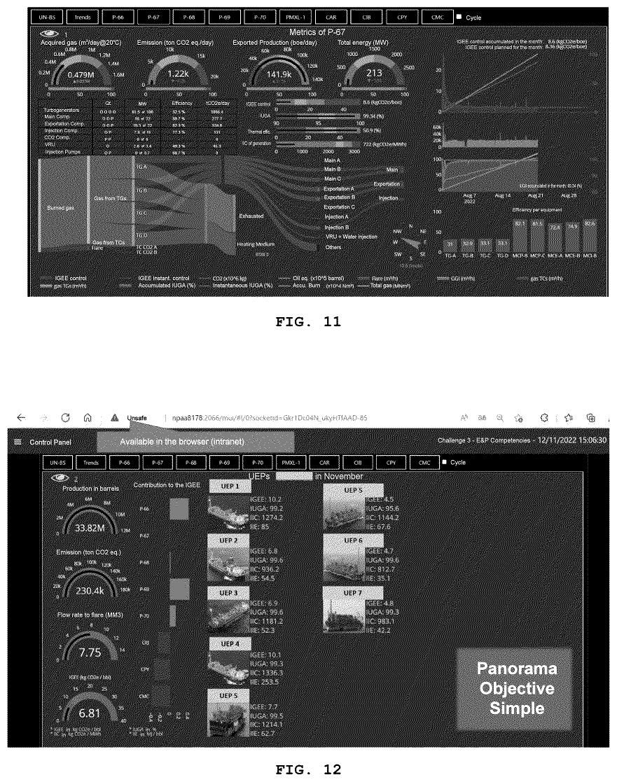

FIG. 12 shows a main screen of the panel, as defined by the present invention. On this first screen, a portfolio of SPUs can be seen—in the example, the UM-XX business unit.

The system has a control panel containing a simple and objective view of the SPUs with their main carbon and energy performance indicators. This view allows to compare the current carbon and energy performance of the set of SPUs and global data on production, GHG emissions, flare gas burning and greenhouse gas intensity (IGEE). Additionally, the IUGA (Associated Gas Usage Index) is also supervised monthly, as a legal requirement by the ANP. This indicator is directly related to the flare gas burning limit authorized for the SPU.

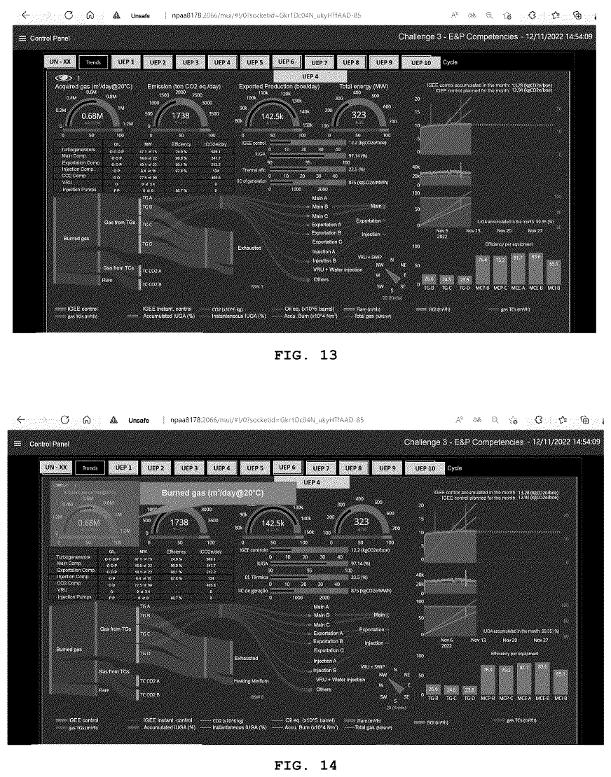

In addition, it is also possible to browse by platform and understand/evaluate each indicator: General view of the SPU; SPUs performance vision; Efficiency by equipment, etc., as best seen in FIG. 13, which presents a screen with detailed information on energy and carbon performance by SPU.

FIG. 14 prominently shows a display of gas acquired for a specific SPU (“Burned gas m³/day @20° C.”). This display presents the portions of flare burning gas and fuel gas consumed in gas turbines and in inert gas generation units (GGI). It further allows the immediate visualization of the relative distribution of the burned gas flow rate through the flare and for power generation and inert gas production (lower horizontal bar). It is recommended that each unit evaluate the acceptable reason for monitoring, according to the operational condition of the SPU.

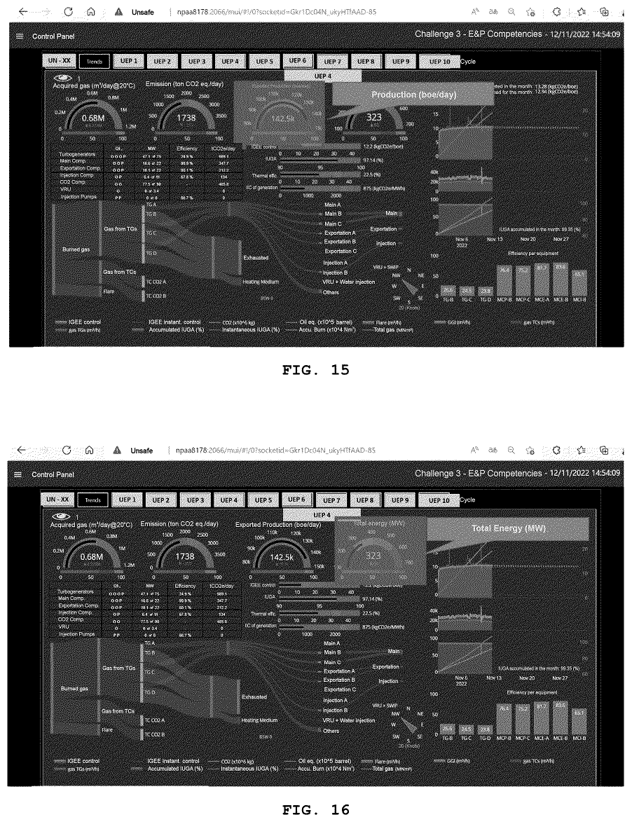

FIG. 15 highlights the display relating to production (boe/day) for a specific SPU. The “Production (boe/day)” display includes the oil production (P_{Oil}) and total Gas production (P_{Gas}) converted into boe/day. It allows the immediate visualization of the relative distribution between P_{Oil} and P_{Gas}.

FIG. 16 highlights the display for total energy (“Total Energy (MW)”). The Total Energy corresponds to the primary energy, in the form of gas produced, consumed by the installation. This metric includes flare burning and fuel gas consumption in gas turbines and inert gas generation units (GGI), in an energy unit. It allows the immediate visualization of the relative distribution between emissions from burning through the flare and emissions for energy generation.

FIG. 17 shows the display for Total CO₂ eq Emission (t/day) for a specific SPU. The total CO₂ eq emission display (t/day) shows the portions of flare burning gas and fuel gas consumed in gas turbines and inert gas generation (GGI) for energy generation calculated as CO₂ equivalent. It allows the immediate visualization of the relative distribution between emissions from burning and emissions for energy generation (lower horizontal bar).

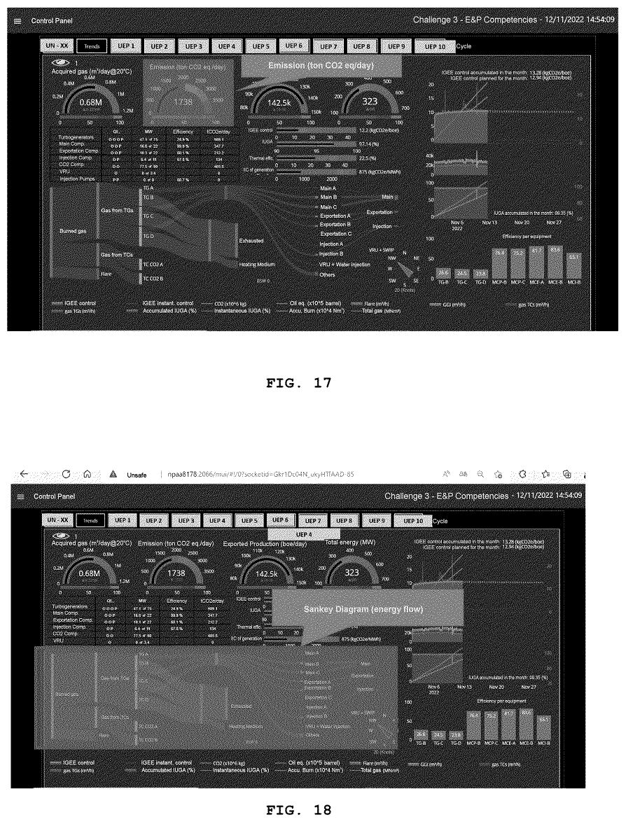

The overview of energy flow through the installation is presented by using a Sankey chart, as shown in FIG. 18, which allows viewing the portions of primary energy converted into useful energy, energy waste to the environment, plant operating mode of primary processing, systems and equipment stopped and in operation, according to the operational condition of the installation at a given instant of time.

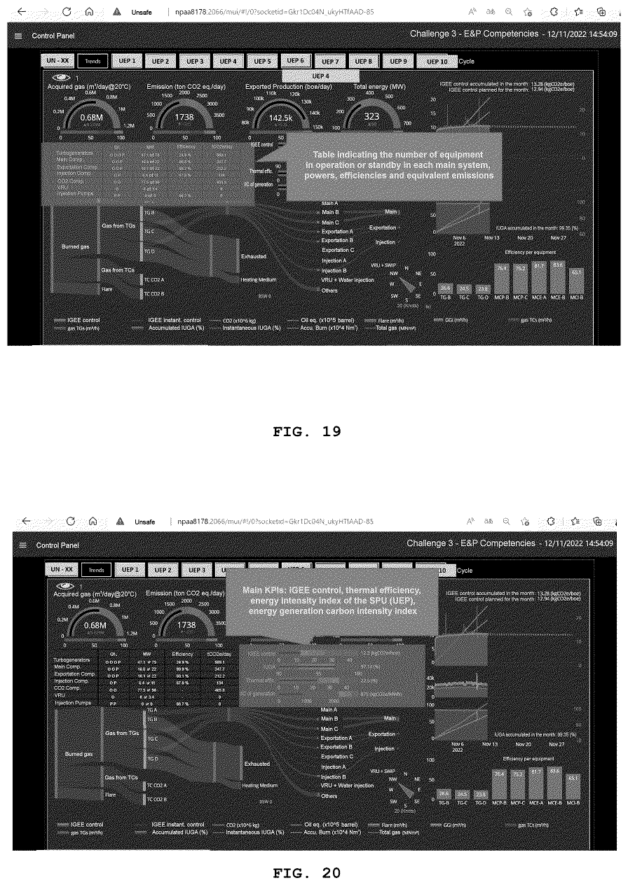

Based on the “Systems Availability and Performance Vision” (table with the main SPU systems), it is possible to evaluate in a consolidated manner the operational availability of the main equipment related to energy use and consumption: Equipment availability: O (Operating) and P (Stopped); Generation carried out compared to the Generation capacity; Operation efficiency and carbon efficiency. It is further possible, for example, in the case of the turbogenerators, to evaluate the optimization of the number of machines in operation to maximize energy generation efficiency, as shown in FIG. 19. The gas turbines for generating electrical energy are more efficient when operating close to the rated load. When indicating a load generated in MW, for example, assuming 40 MW, while indicating 3 turbines in operation with a total generation potential of 75 MW, it is ascertained that the same generation load could be met with only 2 turbines operating closer together of their rated loads. A survey based on field data showed that, for the same generation load, the operation of 4 turbines, where 3 turbines would serve, increases CO2e emissions by around 10%.

With the implementation of the system, it was also possible to notice gains in optimizing the operation of turbines on UN-YY platforms (for example: P-YY). It was also possible to detect a divergence in the emissions calculations of SIGEA®—Atmospheric Emissions Management System and the Energy and Carbon Panel on an UN-XX platform. This made it possible to work on SIGEA® to update the composition of the used fuel, which improved the inventory, bringing greater accuracy to the SPU emissions inventory, which makes up the monthly GHG Emissions Intensity indicator.

The implementation of the Performance Panel of the present invention in the specified SPUs enabled the joint and routine assessment of the main operational aspects related to GHG emissions. This allowed the identification of optimization opportunities and the monitoring of their execution, which resulted in an important reduction in CO2e emissions and the result of the IGEE indicator.

FIG. 20 shows in a highlighted way an “indicator” view for a specific SPU. It can be noted that the “indicator” view presents the main carbon and energy performance indicators at the installation level (SPU), as follows:
Global thermal efficiency including energy and heat (%);
IIE (GJ/boe): IIE-UEP (SPU Energy Intensity Index);
IGEE control (kg CO₂ eq/boe): GHG Intensity Index considering oil and gas production exported for commercialization (E_{Gas});
IIC (kg CO₂ eq/boe): (Index of carbon intensity of the energy generation).

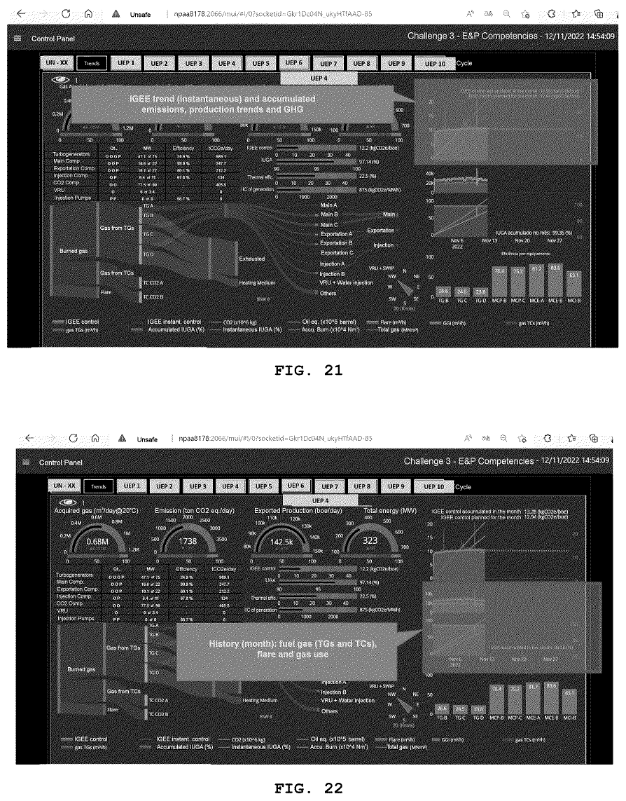

The “trends” view consolidates the accumulated result of the IGEE monthly control up to the current date, allowing the visual analysis of its correlation with the other mapped operational parameters: flare, gas turbochargers (TCs), gas turbogenerators (TGs) and efficiency of TGs, as shown in FIGS. 21 and 22.

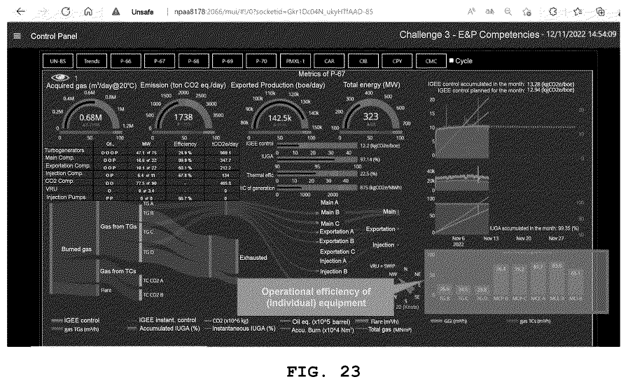

FIG. 23 presents the efficiencies at the equipment level in a consolidated manner, with TG being the turbogenerators, MCP being the motor compressors for the Main compression service, MCE being the motor compressors for the Export compression service and MCI being the motor compressors for the Injection compression service.

Finally, for a better understanding of the invention, definitions of expressions and acronyms used throughout the text are provided below.

BOE: production of Oil (P_{Oil}) and Gas (P_{Gas}) expressed in Barrel of oil equivalent. For IGEE purposes, some adjustments to the P_{Gas} portion must be considered.

Energy consumption—amount of energy used or applied.

GHG—Greenhouse gases calculated as CO₂ equivalent (CO₂ eq), notably CO₂, N₂O and CH₄.

ICH₄-SPU—Intensity of methane (CH₄) emissions, expressed in tCH₄/thousand t of hydrocarbons sold.

IGEE-SPU—SPU GHG Intensity Index, expressed in kg CO₂ eq/boe. Calculated from the equation:

IGEE-SPU=Direct GHG Emissions+Indirect GHG Emissions from SPU/Oil and Gas Production (adjusted for IGEE).

IIE-UEP—SPU Energy Intensity Index.

IGEE-E&P: Greenhouse Gas Intensity in E&P, represented by the ratio between

GHG emissions from the E&P activities, including exploration, production and support activities, and total oil and gas production (wellhead—which arrive at SPU), considering a certain period. Expressed in kg CO₂ eq/boe.

IESG—Generation System Efficiency Index.

IICSG—Generation System Carbon Intensity Index.

IICST—Turbocharging System Carbon Intensity Index.

IET—Turbine Efficiency Index.

IECC—Centrifugal Compressor Efficiency Index.

IEBC—Centrifugal Pump Efficiency Index.

IICCT—Turbine Combustion Carbon Intensity Index.

IICCM—Diesel Engine Combustion Carbon Intensity Index.

IUGA—Produced Gas Utilization Index.

P_{Gas} (Produced Gas): considers the entire volume of gas lifted to the platform,

which, after the processing steps, will be divided into the following portions:

Consumption Gas, Burning Gas (loss), Lift Gas, Injected Gas and Gas Exported (E_{Gas}). For the purposes of calculating BOE, used in calculating IGEE, the percentage of CO₂ must be deducted from the Loss, Injection and E_{Gas} portions, which must represent the gas volume before removing the Liquefied Gas.

Fugitive Emission: these are emissions of organic compounds in piping fixtures and equipment caused, in general, by the gradual loss of tightness. In other words, emission that is not conducted to the atmosphere from a chimney, flue, vent or other functionally equivalent collection system. This type of emission includes, but is not limited to, methane, ethane, VOCs (among which BTEX).

Direct GHG emissions: these are emissions from sources that are controlled by the company. According to the definition of the Brazilian GHG Protocol Program, they are Scope 1 emissions, that is, in the E&P area, they come from combustion sources (fixed and mobile), process sources (point and non-point), non-routine sources (sporadic activities) and fugitives.

Indirect GHG emissions: these are emissions from electrical and thermal energy (steam) generation activities, acquired from third parties for internal consumption in the unit. According to the definition of the Brazilian GHG Protocol Program, these are Scope 2 emissions, in the E&P area, they come from another Business Area or an Electric Energy Distribution company.

Greenhouse Gases (GHG): It is the set of gases that contribute to the intensification of the greenhouse effect and that considers the potential for global warming based on the effect caused by carbon dioxide. The mass of greenhouse gases is calculated considering the following equation, taken from the “Fourth Assessment Report (AR4) of the United Nations Intergovernmental Panel on Climate Change (IPCC)”:

Mass GHG=(Mass CO₂+25*Mass CH₄+298*Mass N₂O).

Fuel gas—Mixture of process gases used in burning to generate energy in the SPU.

Flaring burning gas—portion of the gas sent for burning in the flare.

P_{Oil}—Oil Production.

SIGEA®—Atmospheric Emissions Management System. It is a tool used to calculate emissions and fuel consumption inventories.

Energy use—mode or type of energy application. E.g.: heating, process, activation.

SPU: Stationary Production Unit.

VENT: Ventilation operation conduit for a safe location or vent, which provides adequate dispersion of gases into the atmosphere, without ignition or conversion into other compounds.

Those skilled in the art will value the knowledge presented herein and will be able to reproduce the invention in the presented embodiments and in other variants, encompassed by the scope of the attached claims.

1. An energy and carbon performance monitoring method for stationary production units, comprising:
identifying stored operational data of interest on energy consumption and greenhouse gas emissions;
structuring the operational data of interest;
calculating at least one energy and carbon performance indicator corresponding to at least one level of a stationary production unit (SPU) among: installation, system, equipment, or a combination thereof;
connecting information and structured data obtained from the operational data of one or more stored SPU levels; and
building a display panel to display one or more displays that present the calculated performance indicators in real time.

2. The method of claim 1, wherein the identifying the stored operational data of interest is performed in a plant information infrastructure.

3. The method of claim 1, wherein the structuring the operational data of interest is performed on a plant information asset structure server.

4. The method of claim 1, wherein the structuring the operational data of interest comprises:
organizing assets in order of priority within an asset structure;
standardizing configurations;
centralizing data from multiple sources;
standardizing themes and units of measurement; and
creating result tags.

5. The method of claim 1, wherein the performance indicators are calculated based on energy performance metrics, carbon performance metrics, or a combination thereof.

6. The method of claim 1, wherein the calculation of the energy performance indicator applicable to the installation defined as:
$${IIE}_{UEP} = \frac{{ApEn}_{UEP}}{{PrEx}_{UEP}}$$
wherein:
IIE_{UEP} is an SPU energy intensity indicator, in Btu/boe (MJ/boe);
ApEn_{UEP} is a global energy contribution to the SPU, in Btu (MJ); and
PrEx_{UEP} is a net exported production, in boe.

7. The method of claim 1, wherein the calculation of the energy performance indicator applicable to an electrical energy generation system is defined as:
$${IE}_{SisGer} = A \cdot \frac{{Pot}_{SisGer}}{{\dot{m}}_{f \_ SisGer} . PCI}$$
wherein:
IE_{SisGer} is a global efficiency indicator of the electrical energy generation system of the SPU;
A is an energy conversion factor, 3412.14·kWh/BTU(3600·kWh/kJ);
Pot_{SisGer} is a net electrical power provided by the electrical energy generation system, in kW;
\dot{m}_{f_SisGer} is a total mass flow rate of fuel for the electrical energy generation system, in lb/h (kg/h); and
PCI is a lower calorific value of fuel, in Btu/lb (KJ/kg).

8. The method of claim 1, wherein the calculation of the energy performance indicator applicable to a gas compression system is defined as:
$${IE}_{SisComp} = \frac{{\dot{m}}_{SisComp} . Δ {h}_{SisComp}}{{Pot}_{SisComp}}$$
wherein:
IE_{SisComp} is a global efficiency indicator of the SPU gas compression system;
\dot{m}_{SisComp} is a net mass flow rate delivered by the SPU gas compression system, in lb/s (kg/s);
Δh_{SisComp} is a sum of enthalpy added to gas by all compressor sections, on average between machine trains, in Btu/lb (KJ/kg); and
Pot_{SisComp} is a total power required to activate the SPU gas compression system, in HP (kW).

9. The method of claim 1, wherein the calculation of the energy performance indicator applicable to a gas turbine is defined as:
$${IE}_{Turb} = A \cdot \frac{{Pot}_{Turb}}{{\dot{m}}_{f \_ Turb} . PCI}$$
wherein:
IE_{Turb} is an efficiency indicator of a SPU gas turbine;
A is a energy conversion factor, 3412.14·kWh/BTU(3600·kWh/kJ);
Pot_{Turb} is a shaft power of the SPU gas turbine, in kW;
\dot{m}_{f_Turb} is a total mass flow rate of fuel for the SPU gas turbine, in lb/h (kg/h); and
PCI is a lower calorific value of fuel, in Btu/lb (KJ/kg).

10. The method of claim 1, wherein the calculation of the energy performance indicator applicable to a centrifugal compressor is defined as:
$${T}_{2} = {( \frac{{P}_{2}}{{P}_{1}} )}^{\frac{n - 1}{n}} . {T}_{1} \\ \frac{n - 1}{n} = \frac{k - 1}{k . {IE}_{p}}$$
wherein:
IE_{P} is a polytropic efficiency indicator of the SPU compressor;
T₁ is an absolute temperature at the compressor suction, in K;
T₂ is an absolute temperature at the compressor discharge, in K;
P₁ is an absolute pressure at the compressor suction, in kPa;
P₂ is an absolute pressure at the compressor discharge, in kPa;
k is an adiabatic expansion coefficient; and
n is a polytropic exponent.

11. The method of claim 1, wherein the calculation of the energy performance indicator applicable to a centrifugal pump is defined as:
$${IE}_{b} = \frac{Δ P . \dot{Q}}{{Pot}_{abs}}$$
wherein:
IE_{b} is an efficiency indicator of a SPU centrifugal pump;
Δp is a differential pressure provided by the SPU centrifugal pump, in kPa;
\dot{Q} is a volumetric flow rate of the pumped fluid, in m³/s; and
Pot_{abs} is a power absorbed by the SPU centrifugal pump, in kW.

12. The method of claim 1, wherein the calculation of the carbon performance indicator applicable to the installation is defined as:
$$IGEE = \frac{{EmCO}_{2 \_ UEP}}{{PrEx}_{UEP}}$$
wherein:
IGEE is a greenhouse gas intensity indicator of the SPU, in kg CO₂/boe;
EmCO_{2_UEP} is a total CO₂ emission associated with energy consumption in the SPU, in kg CO₂; and
PrEx_{UEP} is a net exported production of the SPU, in boe.

13. The method of claim 1, wherein the calculation of the carbon performance indicator applicable to an electrical energy generation system is defined as:
$${IIC}_{SisGer} = \frac{{EmCO}_{2 \_ SisGer}}{{Pot}_{SisGer}}$$
wherein:
IIC_{SisGer} is a carbon intensity indicator of an SPU electrical energy generation system, in kg CO₂/MWh;
EmCO_{2_SisGer} is a total CO₂ emission associated with the SPU electrical generation system, in kg CO₂/h; and
Pot_{SisGer} is a net electrical power supplied by the SPU electrical energy generation system, in MW.

14. The method of claim 1, wherein the calculation of the carbon performance indicator applicable to the turbocharging system is defined as:
$${IIC}_{SisComp} = \frac{{EmCO}_{2 \_ SisComp}}{{Pot}_{SisComp}}$$
wherein:
IIC_{SisComp} is a carbon intensity indicator of a gas compression system driven by a SPU gas turbine, in kg CO₂/MWh;
EmCO_{2_SisComp} is a total CO₂ emission associated with the gas compression system driven by the SPU gas turbine, in kg CO₂/h; and
Pot_{SisComp} is a net power delivered to gas by the gas compression system driven by a gas turbine, in MW.

15. The method of claim 1, wherein the calculation of the carbon performance indicator applicable to a gas turbine is defined as:
$${IIC}_{TG} = \frac{{EmCO}_{2 \_ TG}}{{Pot}_{TG}}$$
wherein:
IIC_{TG} is a carbon intensity indicator associated with equipment driven by a gas turbine, in kg CO₂/MWh;
EmCO_{2_TG} is an emission associated with a SPU gas turbine, in kg CO₂/h; and
Pot_{TG} is a net power delivered by the SPU gas turbine, in MW.

16. The method of claim 1, wherein the display panel is configured to display one or more displays via a Sankey graph that allows immediate visualization of a distribution of usage portions and gas consumption according to an operating condition of each equipment or system involved in monitoring within the SPU.

17. The method of claim 1, wherein the display panel is configured to display one or more displays via one or more metric dials.

18. An energy and carbon performance monitoring system for stationary production units, implemented on a computer, comprising:
a memory;
a processor; and
a screen;
wherein the memory contains a set of instructions that, when executed by the processor, perform the following steps:
identifying stored operational data of interest on energy consumption and greenhouse gas emissions;
structuring the operational data of interest;
calculating at least one energy and carbon performance indicator corresponding to at least one level of a stationary production unit (SPU) among:
installation, system, equipment, or a combination thereof;
connecting information and structured data obtained from the operational data of one or more stored SPU levels; and
building a display panel to display, on the screen, one or more displays that present the calculated performance indicators in real time.
